(19) United States
(12) Patent Application Publication
(10) Pub. No.: US 2022/0373068 A1
(43) Pub. Date: Nov. 24, 2022

(54) FLUID COUPLING FOR A CONTINUOUS VARIABLE TRANSMISSION

(71) Applicant: Staporn Suprichakorn, Bangkok (TH)

(72) Inventor: Staporn Suprichakorn, Bangkok (TH)

(21) Appl. No.: 17/642,110

(22) PCT Filed: Jun. 24, 2020
(86) PCT No.: PCT/IB2020/055960

§ 371 Date: Mar. 10, 2022

Related U.S. Application Data
(60) Provisional application No. 62/898,226, filed on Sep. 10, 2019.

(51) Int. Cl. F16H 41/04

(52) U.S. Cl. CPC F16H 41/04

(57) ABSTRACT

The present invention discloses a fluid coupling and a coupling method for a continuous variable transmission. The fluid coupling comprises a pump having a first demi-torus body, and a turbine having a second demi-torus body. The first and second demi-torus body together forms a torus body. A first set of fluid directing blades radially disposed at the first demi-torus body. The first set of blades extends from a rim of the first demi-torus body and ends at a region proximate to a hub of the first demi-torus body. A second set of fluid directing blades radially disposed at the second demi-torus body. The second set of blades extends from a rim of the second demi-torus body and ends at a region proximate to a hub of the second demi-torus body. The fluid coupling device is configured to de-couple the negative coupling action and provide a continuously variable transmission.

### BACKGROUND OF THE INVENTION

### A. Technical Field

The present invention generally relates to a fluid coupling and a coupling method for a continuous variable transmission.

### B. Description of Related Art

A fluid coupling has been used as a power transmission coupling for ships, industrial machinery, and automobiles. Referring to FIG. 1A to FIG. 1C, the fluid coupling 100 comprises two main parts, namely a pump 102 and a turbine 104. The pump 102 and the turbine 104 are configured with the shape of half a torus with a plurality of flat blades (118, 120) running radially from the hub to the rim of the demi-torus. A split-guide ring (106, 108) having a demi-torus shape is disposed between the hub and the rim of the pump 102 and the turbine 104. The split-guide ring (106, 108) is configured to prevent turbulence in the flow. A housing 110 encases both the pump 102 and turbine 104, and filled with hydraulic fluid. The housing 110 is usually made as an integral part of the pump 102. The housing 110 rotates at the same speed as the pump 102 while the turbine 104 is allowed to rotate at a different speed. Power is input via the housing 110 or pump 102, (represented by arrow 150 in FIG. 2) and output is provided via the turbine 104 (represented by arrow 152 in FIG. 2) connected to an output shaft 114 with a seal 112 to prevent the fluid from leaking. The coupling 100 further comprises retaining rings 116 and bearings 122. The aforementioned arrangement is known as a fluid coupling 100 that has been used in conjunction with gear trains in early automatic transmissions.

During operation, the pump 102 rotates by input from a prime mover, flinging fluid outward due to centrifugal action so that the fluid exits from the pump 102 at point A and immediately enters the turbine at point B as shown in FIG. 2. The momentum of fluid in axial direction and tangential direction attempts to turn the turbine 104 at the speed of the pump 102 or to couple the turbine 104 to the pump 102. The stream of fluid continues to flow while exerting its momentum onto the blades 118 until it exits around the hub from the turbine 104 outlet at point C to the pump 102 inlet at point D. The remaining fluid momentum attempts to turn the pump 102 to the speed of the turbine 104, or couple the pump 102 to the turbine 104. The turbine 104 speed is always lower than the pump 102 speed. Thus, the coupling action that occurs between the turbine outlet and the pump inlet works against the coupling action that occurs between the pump outlet and the turbine inlet. The pump-turbine coupling is called a positive coupling action and the turbine-pump coupling is called a negative coupling action. Power could be transmitted by this fluid coupling because the moment of momentum generated by the positive coupling action is always greater than that by the negative coupling action.

However, the aforementioned fluid coupling 100 has high slippage, low efficiency and inability to multiply torque. The fluid coupling 100 had been used mainly as a moving-off device or a clutch in early automobiles before being superseded by torque converters. Referring to FIG. 3, a plot 300 between Tₜ/Tₚ (ratio of turbine torque to pump torque) and nₜ/nₚ (ratio of turbine speed to pump speed) at constant pump speed is disclosed. The subscript t represents turbine or output and the subscript p represents pump or input. The plot 300 shows that the output(turbine) torque cannot exceed unity or in other words, torque cannot be multiplied.

Therefore, there is a need for a fluid coupling that could minimize slippage, improve efficiency and enable to multiply torque.

### SUMMARY OF THE INVENTION

The present invention discloses a fluid coupling and a coupling method for a continuous variable transmission. The fluid coupling comprises a pump and a turbine. The pump has a first demi-torus body and the turbine has a second demi-torus body. The first and second demi-torus body together forms a torus body. A first set of fluid directing blades or first set of blades are radially disposed at the first demi-torus body. The first set of blades extends from a rim of the first demi-torus body and ends at a region proximate to a hub of the first demi-torus body.

A second set of fluid directing blades or second set of blades radially disposed at the second demi-torus body. The second set of blades extends from a rim of the second demi-torus body and ends at a region proximate to a hub of the second demi-torus body. A first split-guide ring having a demi-torus shape is disposed between the hub and the rim of the pump. A second split-guide ring having a demi-torus shape is disposed between the hub and the rim of the turbine. A housing encases both the pump and turbine, and filled with hydraulic fluid. The split-guide ring is configured to prevent turbulence in the fluid flow.

The housing is made as an integral part of the pump. The housing rotates at the same speed as the pump while the turbine is allowed to rotate at a different speed. Power is input via the housing or pump, and output is provided via the turbine connected to an output shaft with a seal to prevent the fluid from leaking. The coupling further comprises retaining rings and bearings.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1A exemplarily illustrates a sectional view of a prior art fluid coupling, according to an embodiment of the present invention.

FIG. 1B exemplarily illustrates a perspective view of a pump of the prior art fluid coupling, according to an embodiment of the present invention.

FIG. 1C exemplarily illustrates a perspective view of a turbine of the prior art fluid coupling, according to an embodiment of the present invention.

FIG. 2 exemplarily illustrates an operating mechanism of the prior art fluid coupling, according to an embodiment of the present invention.

FIG. 3 exemplarily illustrates a graph of the performance of the prior art fluid coupling, according to an embodiment of the present invention.

FIG. 4A exemplarily illustrates a sectional view of a fluid coupling for a continuous variable transmission, according to an embodiment of the present invention.

FIG. 4B exemplarily illustrates a perspective view of a turbine of the fluid coupling, according to an embodiment of the present invention.

FIG. 4C exemplarily illustrates a perspective view of a pump of the fluid coupling, according to an embodiment of the present invention.

FIG. 5 exemplarily illustrates an operating mechanism of the fluid coupling, according to an embodiment of the present invention.

FIG. 6 exemplarily illustrates a scale model test bench of the fluid coupling, according to an embodiment of the present invention.

FIG. 7 exemplarily illustrates a graph of characteristics of the fluid coupling at constant pump speed, according to an embodiment of the present invention.

FIG. 8 exemplarily illustrates a graph of torque-versus-speed characteristics of an automobile engine at wide open throttle, according to an embodiment of the present invention.

FIG. 9 exemplarily illustrates a torque characteristic of an internal combustion engine at different throttle positions, according to an embodiment of the present invention.

FIG. 10 is a graph illustrating a result of the fluid coupling loaded from 1,800 rpm on the wide-open throttle torque of FIG. 8, according to an embodiment of the present invention.

FIG. 11 is a graph illustrating the number of torque curves of the fluid coupling loaded from different points on an engine torque curve, according to an embodiment of the present invention.

FIG. 12 is a graph illustrating the possible paths that the accelerator pedal could traverse when starting from rest position, according to an embodiment of the present invention.

FIG. 13 is a graph illustrating the rapid acceleration from rest, according to an embodiment of the present invention.

FIG. 14 is a graph illustrating the possible paths that the accelerator pedal can traverse to accelerate from a certain speed to top speed, according to an embodiment of the present invention.

FIG. 15A to FIG. 15C exemplarily illustrates the possible degree of blade trimming for pump and turbine, according to an embodiment of the present invention.

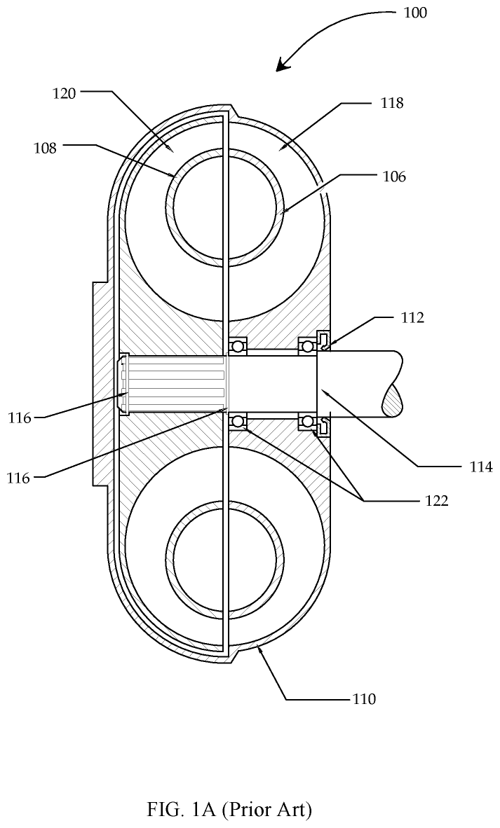

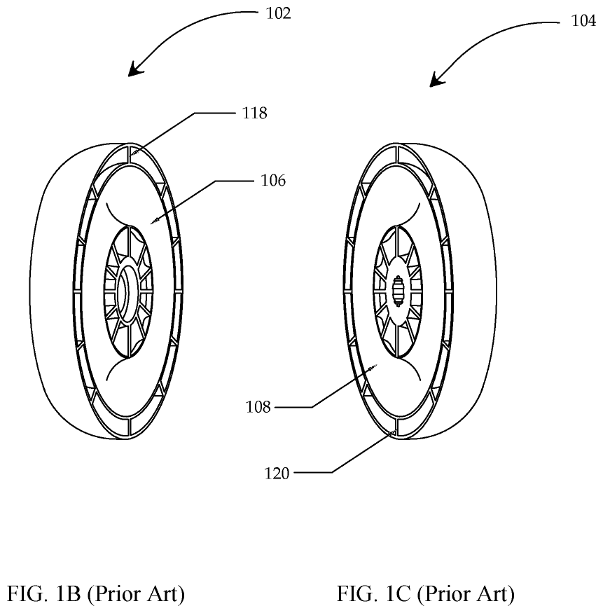

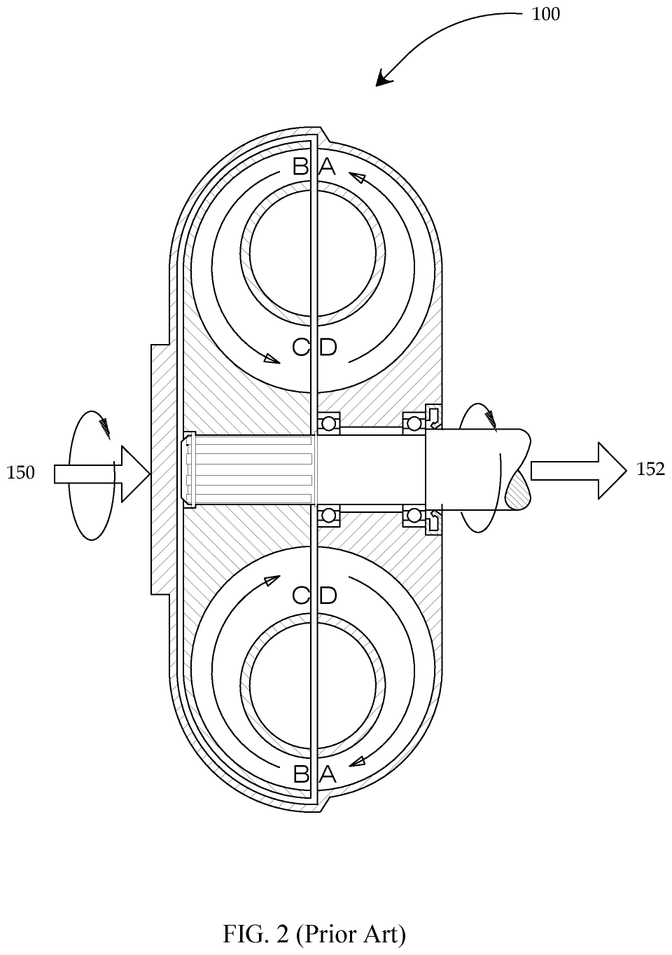

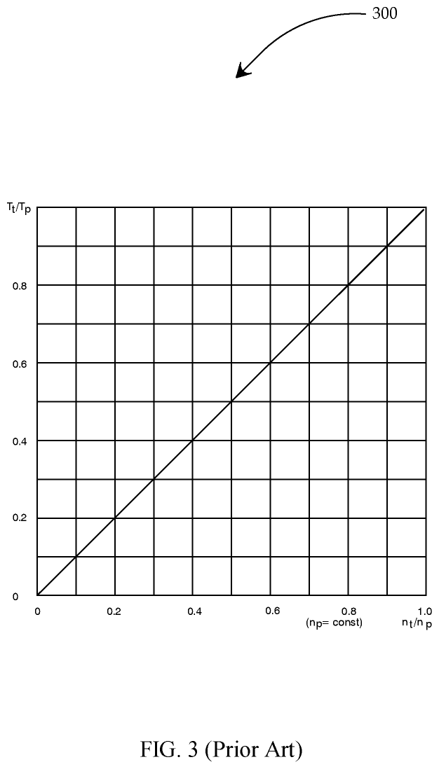

### DETAILED DESCRIPTION OF EMBODIMENTS

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

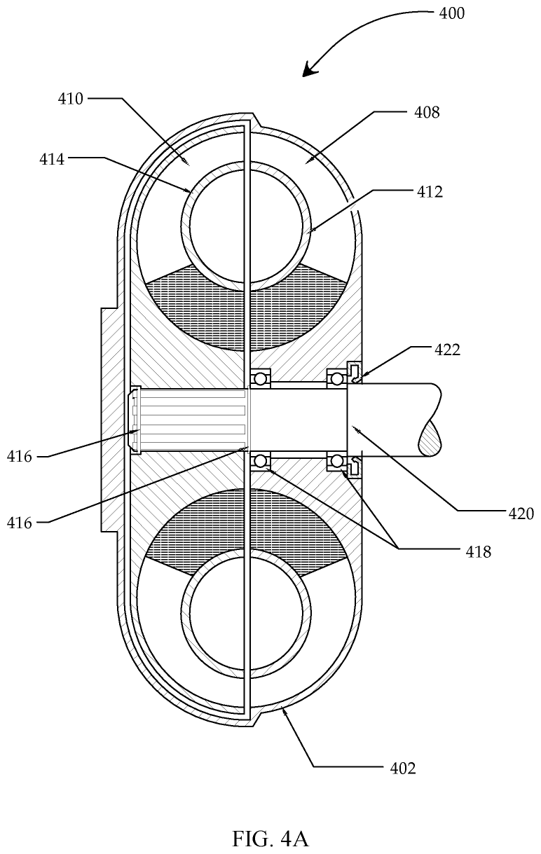

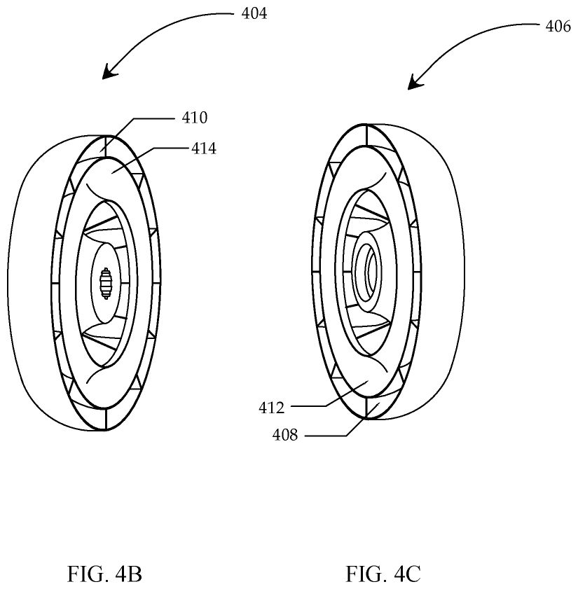

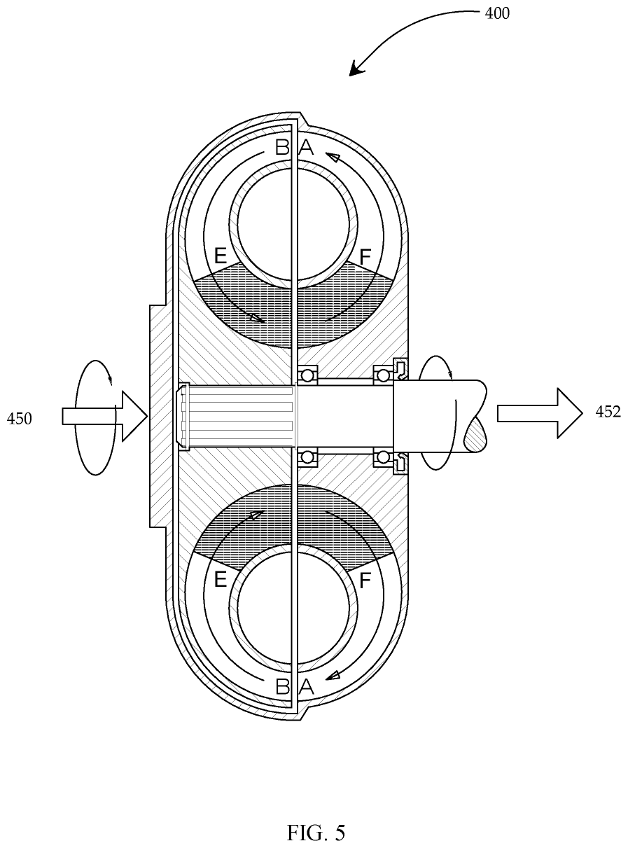

Referring to FIG. 4A, the present invention discloses a fluid coupling 400 and a coupling method for a continuous variable transmission. The fluid coupling 400 is configured to minimize slippage, improve efficiency, enable to multiply torque and provide a continuously variable ratio transmission. The fluid coupling 400 is configured to eliminate the need for mechanical gear to multiply torque in steps. Further, the present invention is a moving-off device.

Referring to FIG. 4A to 4C, the fluid coupling 400 comprises a pump 406 and a turbine 404. The pump 406 has a first demi-torus body and the turbine 404 has a second demi-torus body. The first and second demi-torus body together forms a torus body. A first set of fluid directing blades or first set of blades 408 are radially disposed at the first demi-torus body. The first set of blades 408 extends from a rim of the first demi-torus body and ends at a region proximate to a hub of the first demi-torus body.

A second set of fluid directing blades or second set of blades 410 radially disposed at the second demi-torus body. The second set of blades 410 extends from a rim of the second demi-torus body and ends at a region proximate to a hub of the second demi-torus body. A first split-guide ring 412 having a demi-torus shape is disposed between the hub and the rim of the pump 406. A second split-guide ring 414 having a demi-torus shape is disposed between the hub and the rim of the turbine 404. A housing 402 encases both the pump 406 and turbine 404, and filled with hydraulic fluid. The split-guide ring (412, 414) is configured to prevent turbulence in the fluid flow.

The housing 402 is made as an integral part of the pump 406. The housing 402 rotates at the same speed as the pump 406 while the turbine 404 is allowed to rotate at a different speed. Power is input via the housing 402 or pump 406, and output is provided via the turbine 204 connected to an output shaft 420 with a seal 422 to prevent the fluid from leaking. The coupling 400 further comprises retaining rings 416 and bearings 418.

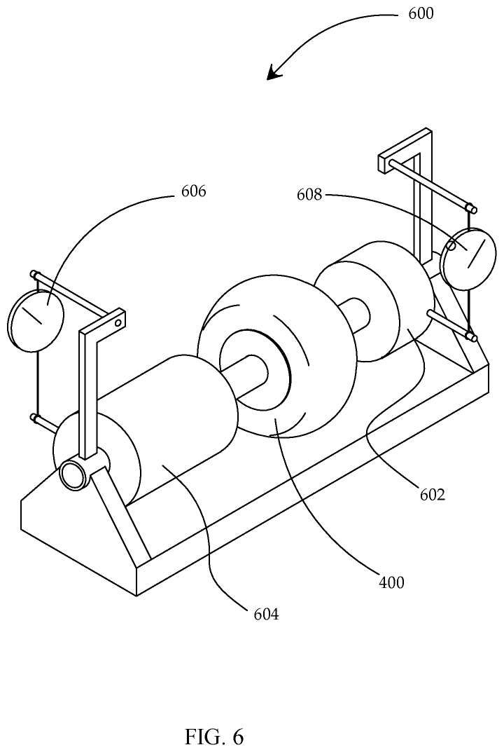

Referring to FIG. 5, the fluid coupling 400 receives input through housing, represented by numeral 450, and outputs through shaft, represented by numeral 452. During operation, the pump 406 rotates by input from a prime mover, flinging fluid outward due to centrifugal action so that the fluid exits from the pump 406 at point A and immediately enters the turbine at point B as shown in FIG. 5. The momentum of fluid in axial direction and tangential direction attempts to turn the turbine 404 at the speed of the pump 406 or to couple the turbine 404 to the pump 406. The stream of fluid continues to flow while exerting its momentum onto the blades 408 until it exits around the hub from the turbine 404 outlet at point E to the pump 406 inlet at point F.

Both the first demi-torus body and the second demi-torus body comprises an area around the hub free of blade elements. Such modification de-couples the negative coupling action by letting the fluid to leave the turbine 404 at E and enter the pump 406 at F as in FIG. 5. Traveling from E to F, the fluid has no influence on second set of turbine blades 410 or first set of pump blades 408 but just starts at E with vortex motion and accelerates the vortex speed so that it enters the pump 406 at F the same way as any radial-flow pump does. With this configuration the fluid coupling 400 turns itself into an continuously variable transmission, or better known as a CVT that; starts off from rest with very high torque ratio, runs at constant speed at a torque ratio close to unity, reacts to a sudden acceleration by a torque ratio greater than unity or “downshifts” and exhibits “engine braking effect” when coasting. All the said phenomena occur without the aid of any external control.

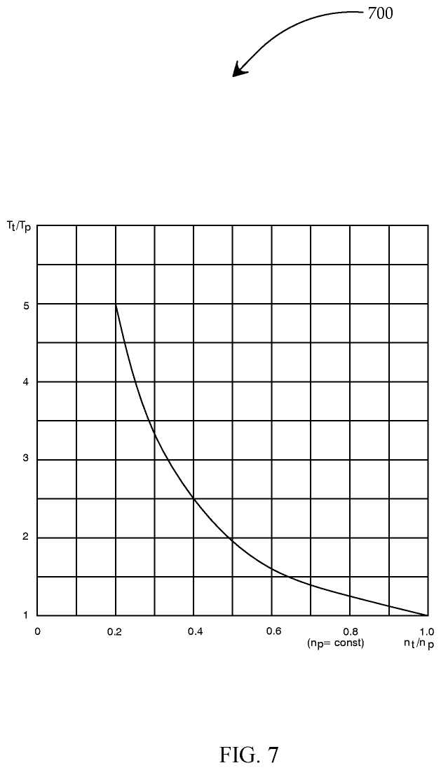

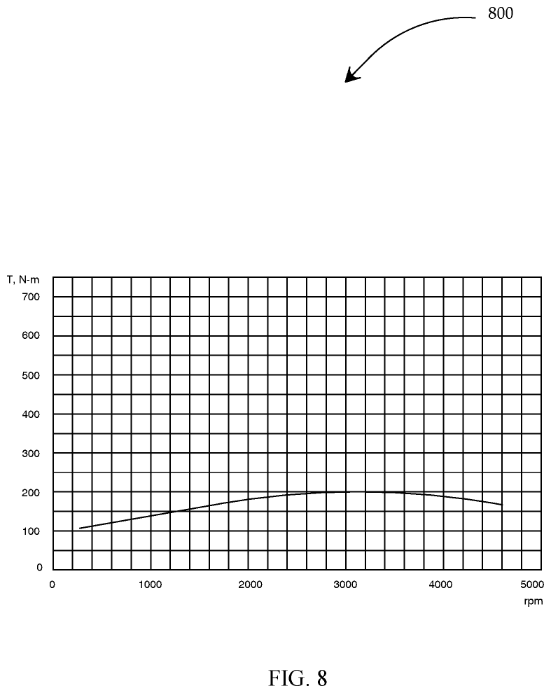

Referring to FIG. 6, a scale model 600 of the fluid coupling 400 is disclosed. The scale model 600 includes force scales (606, 608), fluid coupling 400, eddy current brake 602 and motor 604. The scale model 600 could be tested on a dynamometer at constant input speed. A set of data was obtained and plotted as shown in FIG. 7. The graph 700 shows the ratio of the output torque to input torque (Tₜ/Tₚ) versus the ratio of output speed to input speed (nₜ/nₚ). The graph 700 represents the characteristics of the fluid coupling 400 at one constant pump speed. In one embodiment, another similar graph could be obtained from another pump speed, which discloses that there would be an infinite number of performance curves for the whole operating speed range of the fluid coupling 400. FIG. 8 exemplarily illustrates a graph 800 showing torque-versus-speed characteristics of an automobile engine at wide open throttle, according to an embodiment of the present invention.

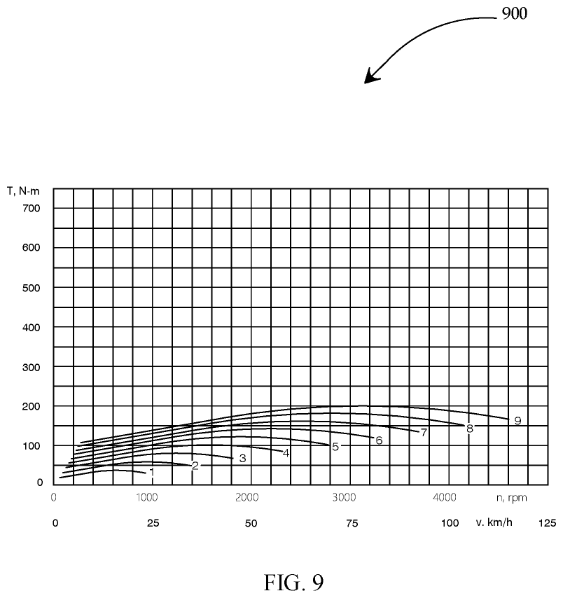

FIG. 9 exemplarily illustrates a graph 900 of a torque characteristic of an internal combustion engine at different throttle positions, according to an embodiment of the present invention. In one embodiment, a curve of torque versus speed could be plotted for each throttle position, and so an infinite number of such curves are available for an infinite number of throttle positions.

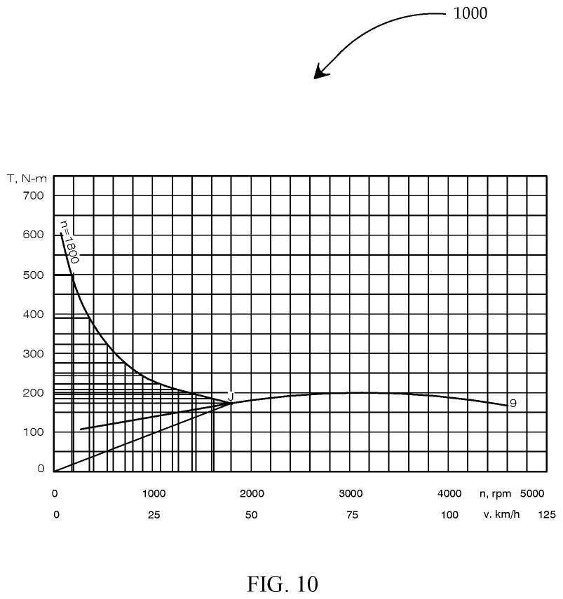

FIG. 10 is a graph 1000 illustrating a result of the fluid coupling loaded from 1,800 rpm on the wide-open throttle torque of FIG. 8, according to an embodiment of the present invention. For example, point J on the curve of FIG. 10, corresponds to the engine speed of 1,800 rpm and a torque of 173 N−m. If the fluid coupling 400 were connected to the engine output shaft, a curve such as that of FIG. 7 could be superimposed on as shown in FIG. 10, which is the engine torque curve at throttle position 9. It would be seen that 1,800 rpm is the point where nₚ/nₚ=1,800 and nₜ=1,800 or nₜ/nₚ=1 while Tₜ/Tₚ=1 or 173 N−m of output torque. At nₜ/nₚ=0.9, the output speed becomes 1,620 rpm and corresponds to approximately 185 N−m of output torque. Similarly, where nₜ/nₚ is 0.8 the corresponding speed and output torque becomes 1,440 rpm and 194 N−m. The full performance curve could be plotted by similar calculations for each point. The line 0-J is the performance graph of a fluid coupling.

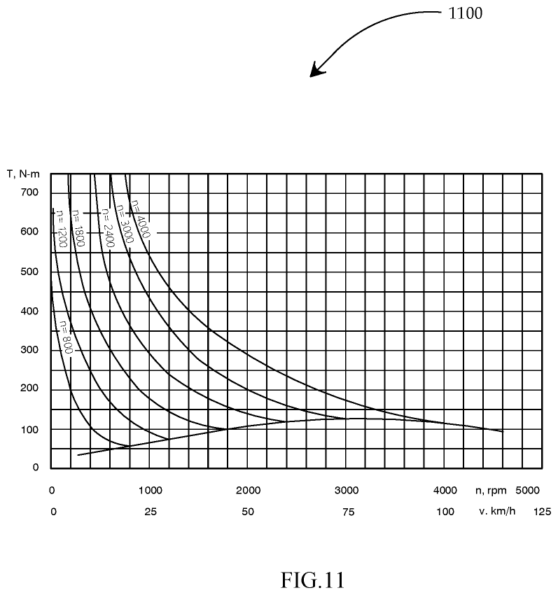

FIG. 11 is a graph 1100 illustrating the number of torque curves of the fluid coupling loaded from different points on an engine torque curve, according to an embodiment of the present invention. There are infinite number of performance curves that could be superimposed on the engine torque-speed curve at one throttle position.

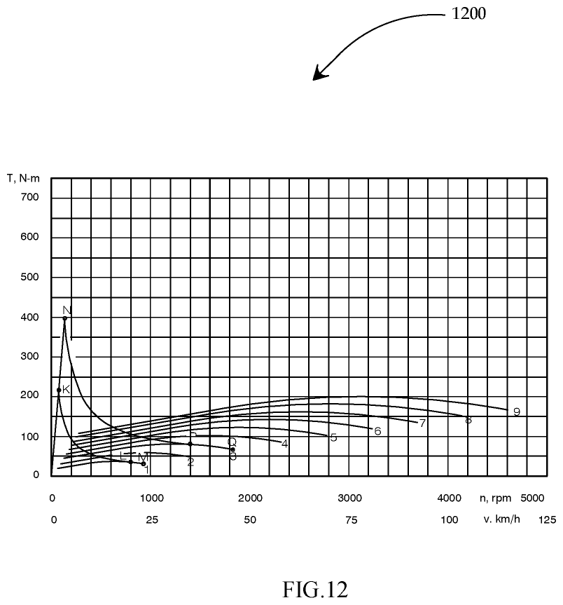

FIG. 12 is a graph 1200 illustrating the possible paths that the accelerator pedal could traverse when starting from rest position, according to an embodiment of the present invention. The graph 1200 shows a relationship between road speed in km/h, engine speed in rpm, the fluid coupling 400 output speed in rpm, engine torque in N−m, the fluid coupling 400 output torque in N−m and throttle position when the output of the fluid coupling 400 is connected to a final drive ratio of 4.5 and a tire diameter of 600 mm.

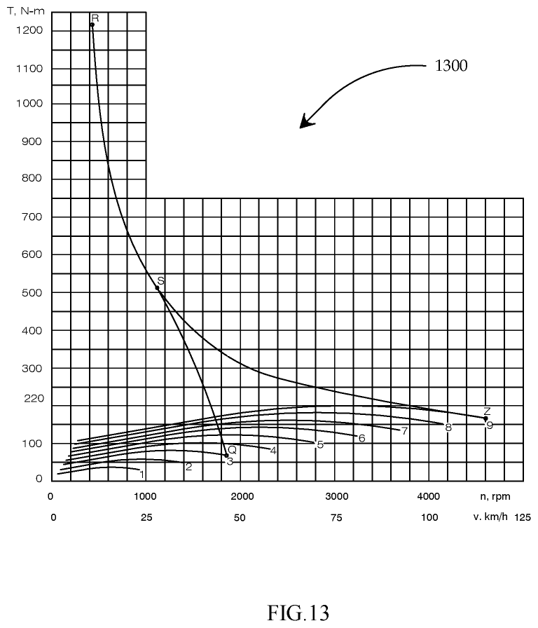

In one embodiment, during starting off, at standstill (v=0), engine running at 800 rpm in throttle position 1, the fluid coupling 400 produces an output torque of 220 N−m at point K but is slipping because the wheel brake is on. Upon releasing the brake while keeping the throttle steady, the vehicle moves along KL and further to M and reach a maximum speed of 23 km/h. The driver may start off more quickly by pressing on the accelerator pedal to throttle position 3 where starting torque is 400 N−m at point N and if the throttle is kept at position 3 the car will accelerate along NP and then to Q where terminal speed is 47 km/h. To reach the 47 km/h goal the driver may press the pedal to the floor to throttle position 9 according to FIG. 13, starting from point R and when reaches point S, eases off the pedal until it reaches throttle position 3 to end up at point Q. The driver may keep the accelerator pedal on the floor until the top speed of 115 km/h is reached at point Z. At constant speed run, the driver does not change the throttle position. FIG. 13 is a graph 1300 illustrating the rapid acceleration from rest, according to an embodiment of the present invention.

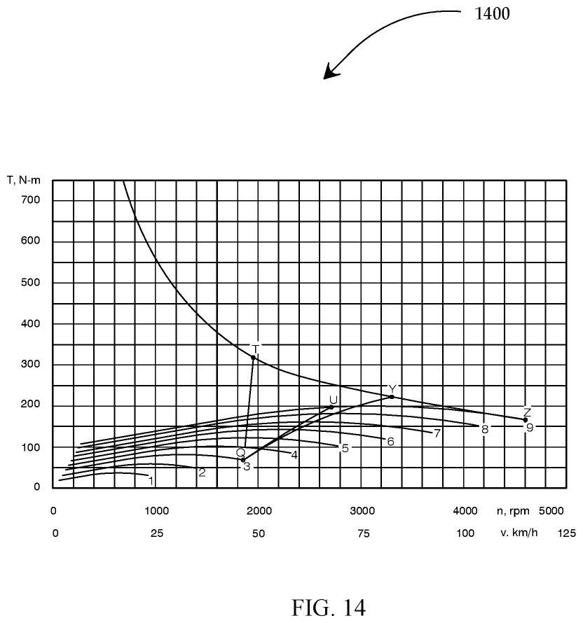

FIG. 14 is a graph 1400 illustrating the possible paths that the accelerator pedal can traverse to accelerate from a certain speed to top speed, according to an embodiment of the present invention. During acceleration, from Q, the driver steps on the pedal quickly to reach point T of throttle position 9 and keeps it there until top speed of 115 km/h is reached at Z. There are many possible gradual accelerations to top speed, i.e. follow QUZ or even more gradually via QYZ. During deceleration, while running at speeds, the driver lifts off the accelerator pedal, the engine speed drops down while the wheel speed slows down a little, the turbine rotates faster than the pump and then the pump proper turns to turbine and the turbine proper turns to pump, engine braking takes place.

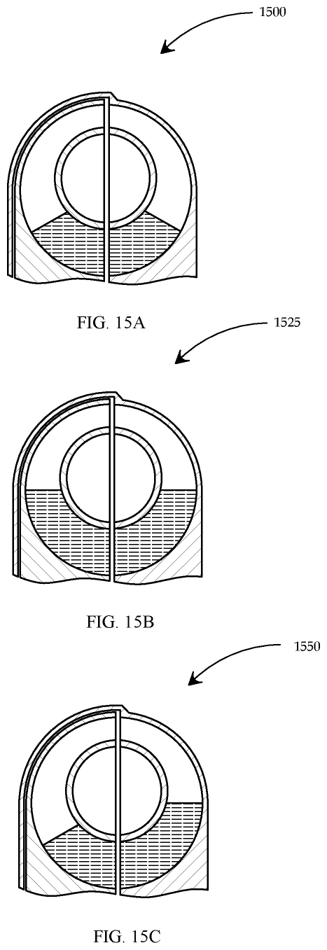

FIG. 15A to FIG. 15C, exemplarily illustrates the possible degree of blade trimming (1500, 1525, 1550) for pump 406 and turbine 404, according to an embodiment of the present invention. FIG. 15A shows the total trimming off angles of pump and turbine blades of 130 degrees, 65 degrees on the pump 406 and 65 degrees on the turbine 404. Increasing the total angle such as in FIG. 15B returns with better efficiency because the working fluid has sufficient distance to adjust its path but this results in larger size of the machine because the torque capacity depends on the impelling area of the pump blade, and also the reaction area of the turbine blades. The trimming off angles could be different on pump blade and turbine blade such as in FIG. 15C which results in acceleration and engine braking characteristics differing from the symmetrical trimming. Number of blades is also a factor for performance. Too few blades give low torque capacity but too many blades reduce the efficiency.

Advantageously, the present invention minimizes slippage, improves efficiency, enables to multiply torque, provides a continuously variable ratio transmission and eliminates the need for mechanical gear to multiply torque in steps. The present invention is mainly intended for automotive applications. The present invention is used in automotive viable on land, sea and air. The present invention could also be used in any industrial plant where very high starting torque for a rotating machine is needed. The present invention is also well suitable for a prime mover that is able to reverse its direction of rotation because of its radial blades configuration.

[45] The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A fluid coupling device, comprising:
a pump having a first demi-torus body;
a turbine having a second demi-torus body, wherein the first and second demi-torus body together forms a torus body;
a first set of fluid directing blades radially disposed at the first demi-torus body, wherein the first set of blades extends from a rim of the first demi-torus body and ends at a region proximate to a hub of the first demi-torus body, and
a second set of fluid directing blades radially disposed at the second demi-torus body, wherein the second set of blades extends from a rim of the second demi-torus body and ends at a region proximate to a hub of the second demi-torus body.

2. The fluid coupling device of claim 1, further comprises a first split-guide ring having a demi-torus shape disposed between the hub and rim of the first demi-torus body.

3. The fluid coupling device of claim 1, further comprises a second split-guide ring having a demi-torus shape disposed between the hub and rim of the second demi-torus body.

4. The fluid coupling device of claim 1, further comprises a housing to encase the pump and turbine filled with hydraulic fluid.

5. The fluid coupling device of claim 1, wherein the first split-guide ring and the second split-guide ring are configured to prevent turbulence in the fluid flow.

6. The fluid coupling device of claim 1, wherein the first set of fluid directing blades comprises an area around the hub free of blade elements.

7. The fluid coupling device of claim 1, wherein the second set of fluid directing blades comprises an area around the hub free of blade elements.

8. The fluid coupling device of claim 1, is configured to de-couple the negative coupling action and provide a continuously variable transmission.

9. A fluid coupling method, comprising the steps of:
providing a fluid coupling comprising,
a pump having a first demi-torus body;
a turbine having a second demi-torus body, wherein the first and second demi-torus body together forms a torus body;
a first set of fluid directing blades radially disposed at the first demi-torus body, wherein the first set of blades extends from a rim of the first demi-torus body and ends at a region proximate to a hub of the first semi-toroidal body, and
a second set of fluid directing blades radially disposed at the second demi-torus body, wherein the second set of blades extends from a rim of the second demi-torus body and ends at a region proximate to a hub of the second semi-toroidal body,
rotating the pump by input from a prime mover;
flinging a fluid from the pump to the turbine via the first set of fluid directing blades;
rotating the turbine to the speed of the pump on exertion of momentum of fluid onto the second set of fluid directing blades, thereby providing a first positive coupling action; and
flowing of fluid from the turbine to pump without influencing the first and second set of fluid directing blades with vortex motion and accelerates vortex speed, thereby providing second positive coupling action, wherein the first positive coupling action and the second positive coupling action enables to multiply torque and provide a continuously variable transmission.

10. The fluid coupling method of claim 9, wherein the first set of fluid directing blades and the second set of fluid directing blades comprises an area around the hub free of blade elements.

11. A fluid coupling device, comprising:
a pump having a first demi-torus body;
a turbine having a second demi-torus body, wherein the first and second demi-torus body together forms a torus body;
a first set of fluid directing blades radially disposed at the first demi-torus body, wherein the first set of blades extends from a rim of the first demi-torus body and ends at a region proximate to a hub of the first demi-torus body, and wherein the first set of fluid directing blades comprises an area around the hub free of blade elements that receives a fluid into the pump, and
a second set of fluid directing blades radially disposed at the second demi-torus body, wherein the second set of blades extends from a rim of the second demi-torus body and ends at a region proximate to a hub of the second demi-torus body and wherein the second set of fluid directing blades comprises an area around the hub free of blade elements that exits the fluid into the pump from turbine.

12. The fluid coupling device of claim 11, further comprises a housing to encase the pump and turbine filled with the hydraulic fluid.
